(19) United States
(12) Patent Application Publication
(10) Pub. No.: US 2009/0110173 A1
(43) Pub. Date: Apr. 30, 2009

(54) ONE TOUCH CONNECT FOR CALENDAR APPOINTMENTS

(75) Inventor: Morten Elvang-Goransson, Esbo (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/930,442

(22) Filed: Oct. 31, 2007

(51) Int. Cl. H04M 3/42

(52) U.S. Cl. 379/210.01

(57) ABSTRACT

A method that includes receiving an appointment reminder. It is determined whether any contact information is associated with the reminder. If so, the call key of the device is enabled, so that if activated, a communication connection is attempted to be established with the contact identified in the reminder.

### BACKGROUND

1. Field

The disclosed embodiments generally relate to calendaring applications and in particular to establishing communication connections from calendar reminders.

2. Brief Description of Related Developments

Calendaring applications generally provide reminders related to appointments and tasks. A reminder can include basic information related to an appointment. If further details are needed, such as contact information related to the appointment, the user generally has to open the application editor and the particular entry. This can be cumbersome.

It would be advantageous to be able to initiate a call to a contact directly from a reminder by activating the call key on the device.

### SUMMARY

In one aspect the disclosed embodiments are directed to a method that includes receiving an appointment reminder. It is determined whether any contact information is associated with the reminder. If so, the call key of the device is enabled, so that if activated, a communication connection is attempted with the contact.

In another aspect the disclosed embodiments are directed to an apparatus. In one embodiment the apparatus includes a processor configured to send a reminder from a calendar application, a processor configured to detect at least one communication contact data in the reminder, and a processor configured to enable a call key of the device to establish a communication connection using the contact data when the call key is activated.

In a further aspect, the disclosed embodiments are directed to a system. In one embodiment, the system includes means for receiving a reminder from an application, means for detecting at least one communication contact data in the reminder, means for linking the at least one communication contact data to a connect function of the device, and means for enabling the connect function to establish a communication connection to the at least one communication contact data.

In yet another aspect, the disclosed embodiments are directed to a computer program product stored in a memory. In one embodiment, the computer program product includes a computer useable medium having computer readable code means embodied therein for causing a computer to enable a communication connection with a contact in a reminder. The computer readable code means in the computer program product also includes computer readable program code means for causing a computer to receive a reminder from an application, computer readable program code means for causing a computer to detect at least one communication contact data in the reminder, and computer readable program code means for causing a computer to enable the connect function to establish a communication connection to the at least one communication contact data.

### BRIEF DESCRIPTION OF THE DRAWINGS

The foregoing aspects and other features of the embodiments are explained in the following description, with reference to the accompanying drawings, in which:

FIG. 1 illustrates one example of a system in which aspects of the disclosed embodiments may be applied;

FIG. 2 illustrates one example of a process according to the disclosed embodiments;

FIG. 3 illustrates one example of a user interface according to the disclosed embodiments;

FIGS. 4a and 4b illustrate examples of exemplary devices that can be used to practice aspects of the disclosed embodiments;

FIG. 5 illustrates one example of an architecture that can be used to practice aspects of the disclosed embodiments.

### DETAILED DESCRIPTION OF THE EMBODIMENT(S)

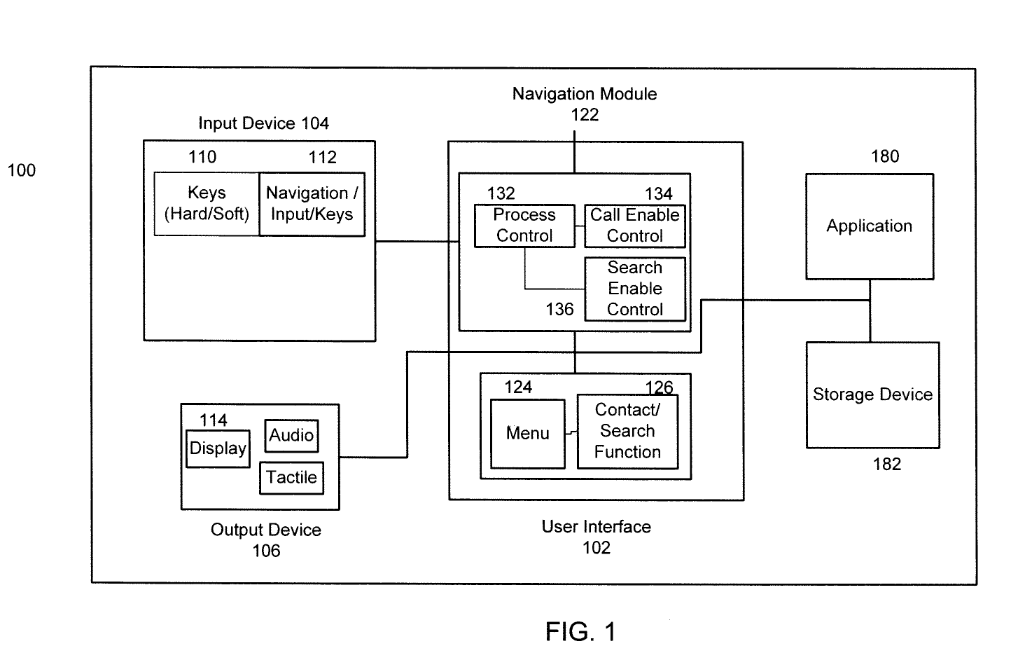

Referring to FIG. 1, one embodiment of a system 100 is illustrated that can be used to practice aspects of the claimed invention. Although aspects of the claimed invention will be described with reference to the embodiments shown in the drawings and described below, it should be understood that these aspects could be embodied in many alternate forms of embodiments. In addition, any suitable size, shape or type of elements or materials could be used.

The disclosed embodiments generally allow a user of a device or system, such as the system 100 shown in FIG. 1, to identify a contact that is part of an appointment or task reminder, and enable a connect or call key of the device to establish a communication connection with the contact when the connect or call key is activated. This provides the advantage that a user can easily and quickly establish a communication connection with a contact from a reminder for an appointment or other task, without the need to open or access additional data or the underlying application.

In one embodiment, when a calendar or other task reminder is received, the contact data in the reminder will automatically be linked to a call button or key of the device. The user can establish a communication connection, such as calling the contact, by activating the connect or call key. For example, when the reminder is a conference call reminder, the call key of the device can automatically be linked to the conference call number. When the user activates the call key, the user is automatically connected to the call, without having to look up any information on the conference call.

Referring to FIG. 1, the system 100 of FIG. 1 can include an input device 104, output device 106, navigation module 122, applications area 180 and storage/memory device 182. The components described herein are merely exemplary and are not intended to encompass all components that can be included in a system 100. In one embodiment, the system 100 comprises a communication device, such as a mobile communication device or other internet application enabled device. In alternate embodiments, the system 100 can include other devices for that include contact applications and databases, including calendaring and appointment or task applications.

While the input device 104 and output device 106 are shown as separate devices, in one embodiment, the input device 104 and output device 106 can be part of, and form aspects of the user interface 102. The user interface 102 can be used to display application and element information to the user, and allow the user to receive and view reminders, and interact with the various applications of the device, as well as to initiate a call to a contact that is associated with a reminder.

In one embodiment, the user interface of the disclosed embodiments can be implemented on or in a device that includes a touch screen display. In alternate embodiments, the aspects of the user interface disclosed herein can be embodied on any suitable device that will display information and allow the selection and activation of applications. In one embodiment, the user interface of the disclosed embodiments can be implemented on or in a device that includes a touch screen display or a proximity screen device. In alternate embodiments, the aspects of the user interface disclosed herein can be embodied on any suitable device that will display information and allow the selection and activation of applications. The terms “select”, “move”, “drag” “contact” and “touch” are generally described herein with respect to a touch-screen display. However, in alternate embodiments, the terms are intended to encompass the required user action with respect to other input devices. For example, with respect to a proximity screen device, it is not necessary for the user to make direct contact in order to select, move or drag and object or other information. Thus, the above-noted terms are intended to encompass that a user only needs to be within the proximity of the device to carry out the desired function. For example, the term “contact” when used in the context of a proximity screen device, does not imply direct contact, but rather near or close contact, that activates the proximity device. Similarly, the scope of the intended devices is not limited to single touch or contact devices. The aspects of the disclosed embodiments can include multi-touch devices where contact, or proximity contact, by one or more fingers or other pointing devices can navigate on and about the screen.

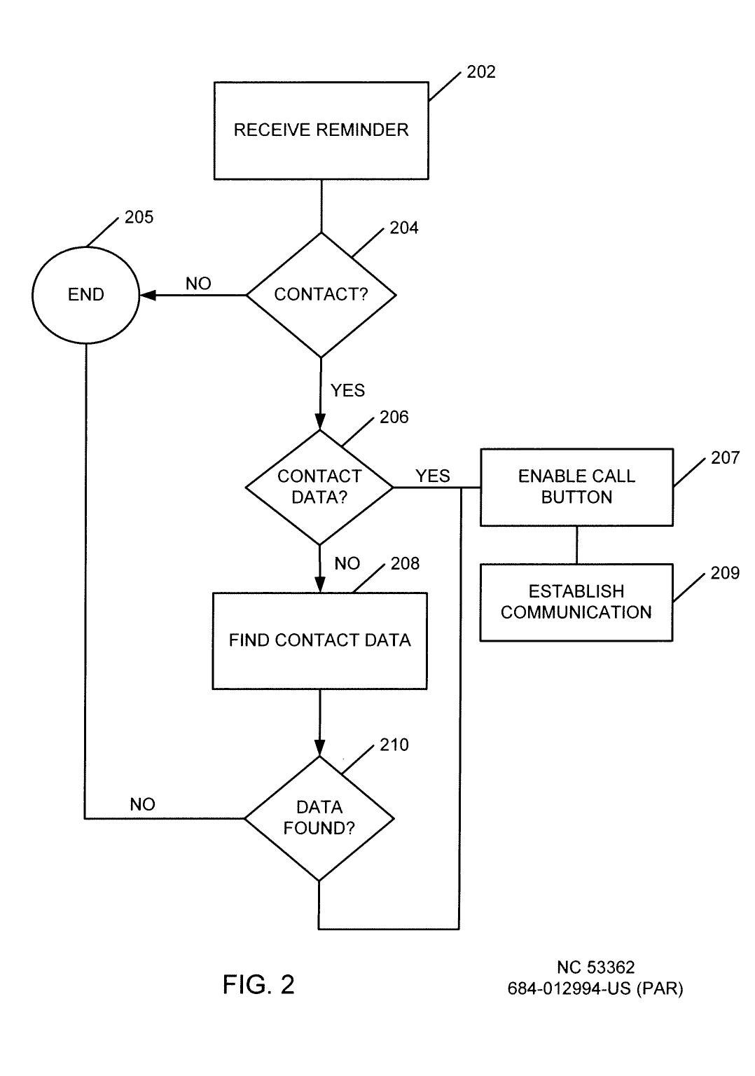

The disclosed embodiments are directed to initiating a communication connection with a contact by activating the call key of the device from a reminder sent to the user. Referring to FIG. 2, a user receives 202 a reminder. The reminder can comprise a calendar appointment, an action due or a task reminder, for example. In alternate embodiments, the reminder can comprise any suitable application that provides information on actions, tasks and events. The reminder can be internally generated by the user's device, or even sent to the user's device by an external application. Once the reminder is received 202, it can be displayed or presented to the user in any desirable fashion. It is determined 204 whether a contact is associated with the reminder. If no, the process can end 205. If yes, it is determined 206 whether the contact data, such as a telephone number or electronic mail or messaging address, is associated with the reminder. If yes, a call or connect function or key of the device can be enabled 207, so that when the function is activated, a suitable communication connection will be attempted with the contact. For example, if the contact data is a telephone number, a call to the number will be attempted when the call function is activated.

In one embodiment, if no contact data is associated with the reminder, a search 208 can be carried out to find 210 contact data related to the contact. In one embodiment, this can comprise searching a contact application of the device, such as for example a phone book or address book. In alternate embodiments, a search of an external database, application or server that stores contact data can be searched. Examples might include a white pages directory, telephone number database or email address database. A prompt may be displayed on the user interface of the device that will ask the user if they wish to execute a search for contact data, or additional contact data. In one embodiment, the contact or call function key can be enabled so that it is associated with the search function and when activated causes a search to additional contact information to be executed.

If no contact data can be located, the process can end 205. If contact data is located, the call button or function on the device can then be enabled 207 to establish 209 a communication link with the contact in the reminder when the function is activated. For example, if the reminder is for an appointment, the user can contact the subject of the appointment without having to open up the calendar entry. If the reminder is for a conference call, the user can enter the conference by simply activating the call button of the device without having to open the appointment to view the conference connection details.

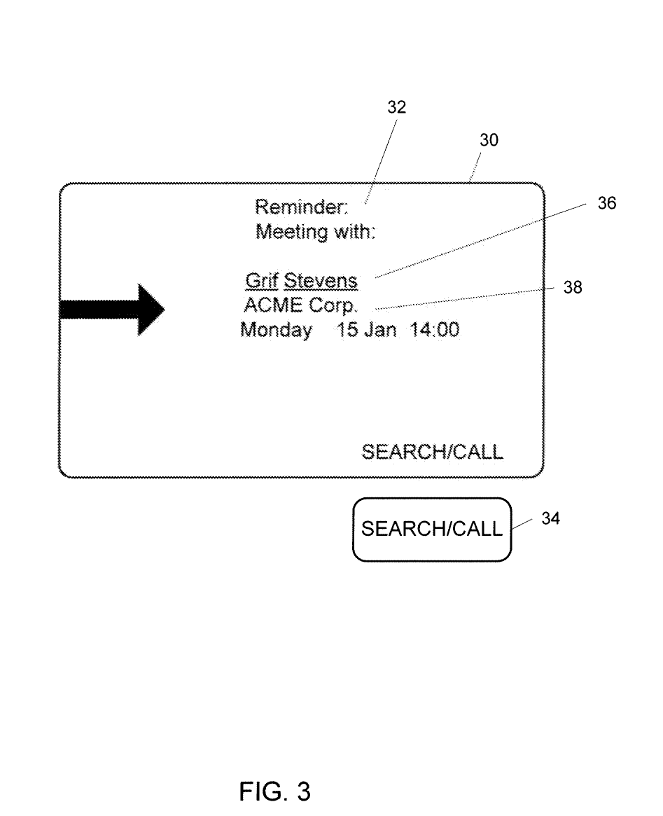

FIG. 3 illustrates one example of a user interface 30 incorporating aspects of the disclosed embodiments. A reminder 32 for a meeting is shown on the display. A contact 36 is shown, together with other identifying information 38. In one embodiment, if contact data, such as a phone number, is not part of the reminder, a search of the contact name is carried out. If contact data is found, the contact name 36 can be highlighted together with the call key 34 of the device. This indicates that the call key 34 is enabled to connect with, or call, the contact 36. In one embodiment, if contact data cannot be found for the contact 36, another search can be carried out for contact data related to the other identifying information 38, such as the person's or the company name. In that situation, the button 34 might be enabled for a search function. If such information is found, the company name 38 would be highlighted and linked to the call key 34 to establish a communication connection.

The aspects of the disclosed embodiments can be implemented on any device that includes a user interface for the display and accessing of information, such as the system 100 shown in FIG. 1. In one embodiment, the input device 104 can generally comprise a keypad or other suitable input mechanism. For example, in one embodiment, the input device 104 can include a touch screen display 112. The inputs and commands from a user, such as the touching of the screen, are received in the input module 104 and passed to the navigation module 122 for processing. The navigation module 122 can determine and set the state of the device. The output device 106, can receive data from the user interface 102, application 180 and storage device 182, for output to the user in a suitable format.

Each of the input device 104 and output device 106 are configured to receive data or signals in any format, configure the data or signals to a format compatible with the application or device 100, and then output the configured data or signals. While a display 114 is shown as part of the output device 106, in other embodiments, the output device 106 could also include other components and device that transmit or present information to a user, including for example audio devices and tactile devices.

The user input device 104 can include controls that allow the user to interact with and input information and commands to the device 100. The output device 106 can be configured to provide the content of the exemplary screen shots shown herein, which are presented to the user via the functionality of the display 114. Where a touch screen device is used, the displays 112 and 114 can comprise the same or parts of the same display. User inputs to the touch screen display are processed by, for example, the touch screen input control 112 of the input device 104. The input device 104 can also be configured to process new content and communications to the system 100. The navigation module 122 can provide controls and menu selections, and process commands and requests. Application and content objects selection and activation can be provided by the menu control system 124. The process control system 132 can receive and interpret commands and other inputs, interface with the application module 180, storage device 180 and serve content as required. The navigation module 122 can include a call enable module 134 and search enable module 136 to execute the call connection and search function described herein. The user interface 102 of the embodiments described herein can include aspects of the input device 104 and output device 106 and a contact/search function menu 126 can be used to provide the user interface functionality of the function to the user.

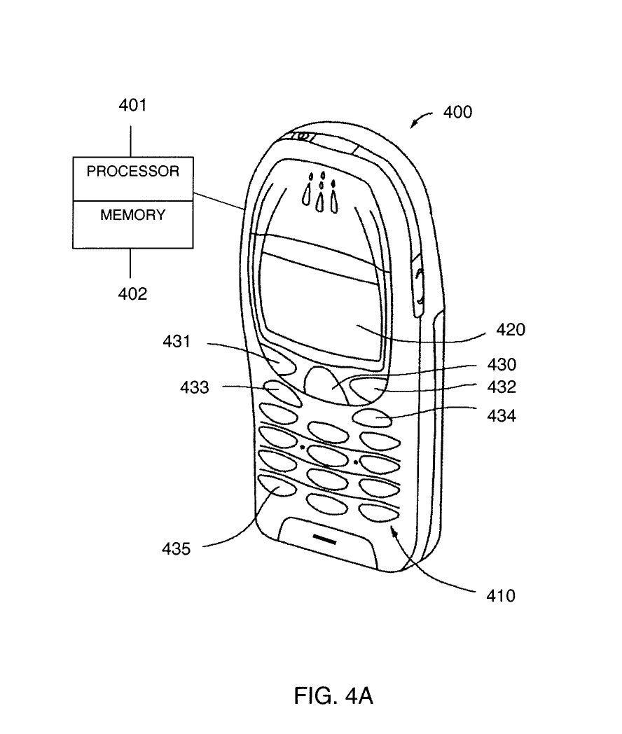

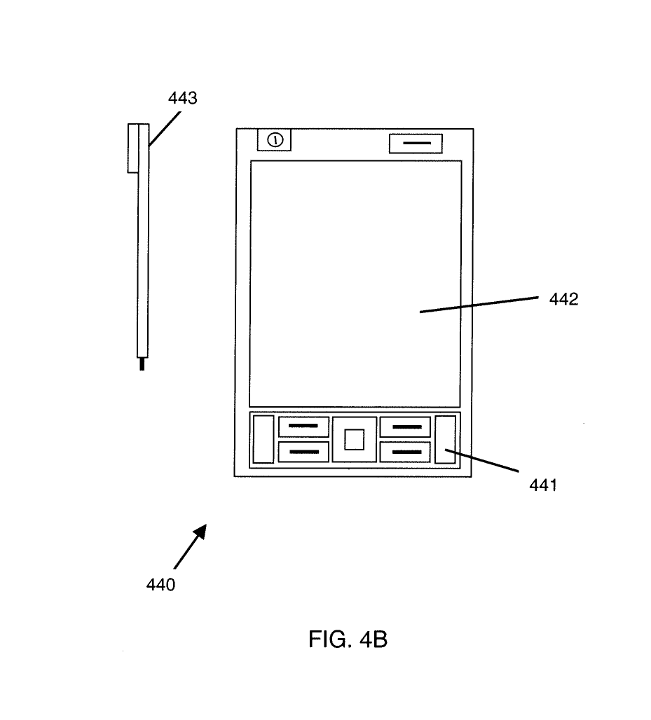

Examples of devices on which aspects of the disclosed embodiments can be practiced are illustrated with respect to FIGS. 4A and 4B. In alternate embodiments, the devices can include device that has or uses a contact application. The terminal or mobile communications device 400 may have a keypad 410 and a display 420. The keypad 410 may include any suitable user input devices such as, for example, a multi-function/scroll key 430, soft keys 431, 432, a call key 433, an end call key 434 and alphanumeric keys 435. The display 420 may be any suitable display, such as for example, a touch screen display or graphical user interface. The display may be integral to the device 400 or the display may be a peripheral display connected to the device 400. A pointing device, such as for example, a stylus, pen or simply the user's finger may be used with the display 420. In alternate embodiments any suitable pointing device may be used. In other alternate embodiments, the display may be a conventional display. The device 400 may also include other suitable features such as, for example, a camera, loud speaker, connectivity port or tactile feedback features. The mobile communications device may have a processor 401 connected to the display for processing user inputs and displaying information on the display 420. A memory 402 may be connected to the processor 401 for storing any suitable information and/or applications associated with the mobile communications device 400 such as phone book entries, calendar entries, etc.

In one embodiment, the system 100 of FIG. 1 may be for example, a PDA style device 440 illustrated in FIG. 4B. The PDA 440 may include one or more of the following features, a keypad 441, a touch screen display 442 and a pointing device 443 for use on the touch screen display 442. In still other alternate embodiments, the device may be a personal communicator, a tablet computer, Internet tablet, a laptop or desktop computer, a television or television set top box, or any other suitable device capable of containing the display 442 and supported electronics such as a processor and memory, and capable of including a contact application and/or database. The exemplary embodiments herein will be described with reference to the mobile communications device 400 for exemplary purposes only and it should be understood that the embodiments could be applied equally to any suitable device incorporating a display, processor, memory and supporting software or hardware, that can be used with or include a contacts application, address book or phone book.

The user interface 102 of FIG. 1 can also include a menu system 124 in the navigation module 122. The navigation module 122 provides for the control of certain states, processes and utilities of the device 100. The menu system 124 can provide for the selection of different tools and application options related to the applications or programs running on the device 100. In the embodiments disclosed herein, the navigation module 122 receives certain inputs, such as for example, signals, transmissions, instructions or commands related to the functions of the device 100. Depending on the inputs, the navigation module interprets the commands and directs the process control 132 to execute the commands accordingly. In one embodiment, the menu system 124 can allow of the selection of a contact entry in a reminder to allow the user to establish a direct communication with the contact from the reminder. The process control 132 can interpret the contact field(s) or other data flags and indicators in the reminder. The navigation module 122 can also control the automatic parsing and checking of the event reminders and searching for contact data, as described herein. The navigation module 122 and process control 132 can interpret the data and enable the call functions in accordance with the aspects of the disclosed embodiments.

Activating a control generally includes any suitable manner of selecting or activating a function associated with the device, including touching, pressing or moving the input device. In one embodiment, where the input device 104 comprises control 110, which in one embodiment can comprise a device having a keypad, pressing a key can activate a function. Alternatively, where the control 110 of input device 104 also includes a multifunction rocker style switch, the switch can be used to select a menu item and/or select or activate a function. When the input device 104 includes control 112, which in one embodiment can comprise a touch screen pad, user contact with the touch screen will provide the necessary input. Voice commands and other touch sensitive input devices can also be used. As noted earlier, the input device can comprise a proximity screen where direct contact is not required.

Although the above embodiments are described as being implemented on and with a mobile communication device, it will be understood that the disclosed embodiments can be practiced on any suitable device that can include or interface with a contact application, phone book or address book. For example, the device 100 of FIG. 1 can generally comprise any suitable electronic device, such as for example a personal computer, a personal digital assistant (PDA), a mobile terminal, a mobile communication terminal in the form of a cellular/mobile phone, or a multimedia device or computer. In alternate embodiments, the device 100 of FIG. 1 may be a personal communicator, a mobile phone, a tablet computer, a laptop or desktop computer, a television or television set top box a DVD or High Definition player or any other suitable device capable of containing for example a display 114 shown in FIG. 1, and supported electronics such as the processor 401 and memory 402 of FIG. 4A. For description purposes, the embodiments described herein will be with reference to a mobile communications device for exemplary purposes only and it should be understood that the embodiments could be applied equally to any suitable device incorporating a display, processor, memory and supporting software or hardware. The device 100 may also include other suitable features such as, for example, a camera, loudspeaker, connectivity port or tactile feedback features.

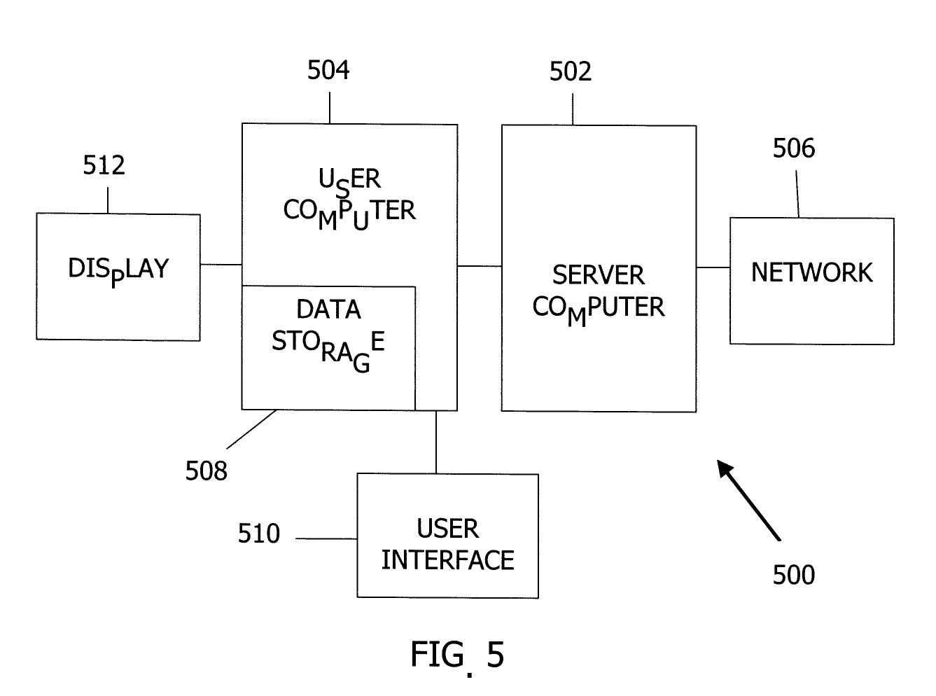

The disclosed embodiments may also include software and computer programs incorporating the process steps and instructions described above that are executed in different computers. FIG. 5 is a block diagram of one embodiment of a typical apparatus 500 incorporating features that may be used to practice aspects of the invention. The apparatus 500 can include computer readable program code means for carrying out and executing the process steps described herein. In one embodiment, the computer readable program code means is stored in a memory of the device or system. As shown, a computer system 502 may be linked to another computer system 504, such that the computers 502 and 504 are capable of sending information to each other and receiving information from each other. In one embodiment, computer system 502 could include a server computer adapted to communicate with a network 506. Computer systems 502 and 504 can be linked together in any conventional manner including, for example, a modem, wireless, hard wire connection, or fiber optic link. Generally, information can be made available to both computer systems 502 and 504 using a communication protocol typically sent over a communication channel or through a dial-up connection on ISDN line. Computers 502 and 504 are generally adapted to utilize program storage devices embodying machine-readable program source code, which is adapted to cause the computers 502 and 504 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 502 and 504 may also include a microprocessor for executing stored programs. Computer 502 may include a data storage device 508 on its program storage device for the storage of information and data. The computer program or software incorporating the processes and method steps incorporating aspects of the invention may be stored in one or more computers 502 and 504 on an otherwise conventional program storage device. In one embodiment, computers 502 and 504 may include a user interface 510, and a display interface 512 from which aspects of the invention can be accessed. The user interface 510 and the display interface 512 can be adapted to allow the input of queries and commands to the system, as well as present the results of the commands and queries.

The disclosed embodiments provide for allowing a user to easily and quickly establish a communication connection with a contact from an appointment or other task. When a calendar or other task reminder is received, the contact data in the reminder will automatically be linked to a call button or key of the device. The user can establish a communication, such as calling the contact, by activating the call key.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

1. A method comprising:
receiving a reminder in a communication device;
automatically highlighting a contact data in the reminder; and
establishing a communication connection with a contact via the contact data by activating a call key on the communication device.

2. The method of claim 1 wherein the contact data is a telephone number and establishing a communication connection comprises calling the number.

3. The method of claim 1 wherein the contact data is an email address and establishing a communication connection comprises opening an email application to create and send an email message to the contact data.

4. The method of claim 1 wherein the contact data corresponds to a text messaging application and establishing a communication connection comprising opening the text messaging application to create and send a text message.

5. The method of claim 1 further comprising linking the highlighted contact data with the enabled call key on a screen of the communication device.

6. The method of claim 1 wherein the reminder is an appointment from a calendar application.

7. The method of claim 1 wherein the reminder is a task from a task application.

8. The method of claim 1 wherein receiving a reminder comprises scrolling over calendar appointments in a calendar application and as each appointment is scrolled over, temporarily enabling the call key of the device to establish a communication connection with the contact data of the appointment for as long as the appointment is selected.

9. The method of claim 1 wherein enabling the call key of the device further comprises providing a voice prompt that the call key is enable to establish the communication connection.

10. The method of claim 1 further comprising, after highlighting the contact data:
searching a contact application database for a telephone number associated with the contact data;
enabling a call key on the device to call the telephone number when the call key is activated.

11. The method of claim 1 wherein the reminder is a conference call reminder and activating the call key comprises connecting to the conference call.

12. An apparatus comprising:
a processor configured to send a reminder from a calendar application;
a processor configured to detect at least one communication contact data in the reminder; and
a processor configured to enable a call key of the device to establish a communication connection using the contact data when the call key is activated.

13. The apparatus of claim 12 wherein the contact data is a telephone number and the processor establishes the communication connection by dialing the number.

14. The apparatus of claim 12, the processor being further configured to highlight the communication contact data and link the highlighted data with a call function of the device.

15. The apparatus of claim 12, the processor being further configured to enable a contact search function of the device when at least one contact communication data is not identified, search a contact application database for additional contact data when the contact search function is activated and enable the call key to connect to the additional contact data when such data is identified.

16. A system comprising:
means for receiving a reminder from an application;
means for detecting at least one communication contact data in the reminder; and
means for linking the at least one communication contact data to a connect function of the device; and
means for enabling the connect function to establish a communication connection to the at least one communication contact data.

17. The system of claim 16, further comprising:
means for enabling a contact search function of the device when at least one contact communication data is not identified;
means for searching a contact application database for additional contact data when the contact search function is activated; and
means for enabling the connect function to connect to the additional contact data when such data is identified.

18. A computer program product stored in a memory comprising:
a computer useable medium having computer readable code means embodied therein for causing a computer to enable a communication connection with a contact in a reminder, the computer readable code means in the computer program product comprising:
computer readable program code means for causing a computer to receive a reminder from an application;
computer readable program code means for causing a computer to detect at least one communication contact data in the reminder; and
computer readable program code means for causing a computer to enable the connect function to establish a communication connection to the at least one communication contact data.

19. The computer program product of claim 18 further comprising:
computer readable program code means for causing a computer to enable a contact search function of the device when at least one contact communication data is not identified;
computer readable program code means for causing a computer to search a contact application database for additional contact data when the contact search function is activated; and
computer readable program code means for causing a computer to enable the connect function to connect to the additional contact data when such data is identified.
